(19) United States
(12) Patent Application Publication
(10) Pub. No.: US 2013/0110724 A1
(43) Pub. Date: May 2, 2013

(54) DUPLICATE CHECK SETTLEMENT DETECTION

(71) Applicant: Drew W. Edwards, Canton, GA (US)

(72) Inventor: Drew W. Edwards, Canton, GA (US)

(21) Appl. No.: 13/663,259

(22) Filed: Oct. 29, 2012

Related U.S. Application Data
(60) Provisional application No. 61/553,150, filed on Oct. 28, 2011.
(60) Provisional application No. 61/577,546, filed on Dec. 19, 2011.

(51) Int. Cl. G06Q 20/40; G06Q 40/00

(52) U.S. Cl. 705/45

(57) ABSTRACT

In a method of determining if a check being presented for settlement is a duplicate, a request is received to convert a check made to a payee to funds. A query is performed on a check processing database to retrieve information about the check indicating whether a query has already been performed on the check processing database for the check when the check had been presented for settlement. In response to determining that a query for the check had previously been performed on the check processing database, an indication is provided.

### BACKGROUND OF THE INVENTION

The present application claims priority to U.S. Provisional Application No. 61/553,150, entitled Duplicate Check Settlement Detection and filed Oct. 28, 2011, and U.S. Provisional Application No. 61/577,546, entitled Duplicate Check Settlement Detection and filed Dec. 19, 2011, the entire disclosure of each of which is incorporated by reference herein.

Checks typically provide a safe and convenient method for an individual to purchase goods and/or services. Checks have certain advantages over other forms of payment, such as cash. For example, while often considered the most liquid type of asset, cash also may be the least secure. Unlike a check, cash is usually freely transferable and does not have to be endorsed. Thus, the same individual is most often both the owner and possessor of cash. Because cash is freely transferable, cash that is lost or stolen typically cannot be recovered. Therefore, the risks associated with cash transactions are often unacceptable, particularly with respect to transactions not conducted in person (e.g., by mail) and/or involving large sums of money. A check, on the other hand, provides a payor with more security because the check usually requires a payor to specify both the person and amount to be paid. Furthermore, as noted above, the check requires a payee's signature to be converted to funds or transferred. These safeguards help to reduce the risk that money will be lost and/or stolen and ensure that the proper payee receives the proper amount of money.

A check payee often has a checking or other depository account at a financial institution into which to deposit funds, which are then available for later withdrawal. Assume a check payee endorses a check and presents the endorsed check to the payee's bank for conversion to funds. The payee bank then submits the endorsed check through the check clearing system, for example through a Federal Reserve Bank, through which the check is ultimately presented to the maker's bank for payment. If the maker's bank agrees to pay the check, funds transfers are made to settle the various intermediary accounts between the maker's bank and the payee's bank. If the maker's bank refuses to pay the check, the check is returned to the payee's depository bank, at which the check amount is deducted from the payee's account, and penalty fees are charged. Where the payee has such an existing account relationship with a bank, the bank may convey to the payee the full amount of the check in currency or deposit the check into the payee's account and make the funds immediately available for withdrawal, even before receiving funds from the payor's bank through the check cashing system. This is acceptable to the payee's bank because the bank has the ability to reverse the funds from the payee's deposit account, and charge related fees, if the check returns from the clearing system unpaid.

If a payee does not have a depository bank relationship, he may still present the check to a bank or, more often, a non-bank check-cashing entity, to convert the check to funds. If the check-cashing entity cashes the check, and the check is returned, the check-cashing entity does not have a deposit account for the check payee against which to charge back the check amount. The check-cashing entity typically charges the payee a fee in this situation, and while the fee does not cover the check amount in the event of return, such fees should cover the check-cashing entity's risk over time and multiple check-cashing transactions.

The check-cashing entity may contract with a check guarantor to provide further comfort that the check is valid and will be honored. The check guarantor is a separate entity that maintains a database of information relating to checks it has processed in the past. Unbanked payees often enroll with check guarantors, which also maintain payee information in their databases. If an unbanked check payee presents a check to a check-cashing entity for cash, the bank obtains identification information from the payee, contacts the check guarantor, and provides the guarantor with the payee's identification information and with information about the check. Based on this information, and upon information provided by its databases, the guarantor makes a recommendation to the check-cashing entity regarding whether the check should be cashed. In some cases, but not always, the guarantor may agree to pay the check amount to the check-cashing entity if the check is returned unpaid.

United States commercial law generally requires a negotiable instrument to be a physical, rather than an electronic, instrument, and, traditionally, checks and other negotiable instruments can only be negotiated through transfer of possession of the physical instrument. The laws embodying the Check Clearing for the 21st Century Act (“Check 21”), however, allow the negotiation of instruments via electronic images of the physical instrument. Since the inception of Check 21, check imaging has become common in the check settlement process, i.e. beginning at the entity (i.e. a bank or non-bank check cashing entity) to which the check is presented, known as the bank of first deposit. For instance, if a payee (whether banked or unbanked) presents a check for deposit or payment at a bank, the bank may image the check and then submit the check image, rather than the physical check, through the settlement process. Further, some commercial check payees (e.g. public utilitites, retailers, and service providers to whom individuals make checks) that receive large volumes of checks from their customers have begun imaging checks to present to their banks for payment. A bank's willingness to allow this activity generally depends upon their “credit view” of the customer depositing the item. The bank expects to get the money back from this customer if they have a problem with the check or if a duplicate check is deposited.

While the Check 21 laws provide flexibility, efficiency and convenience, the electronic depositing of checks, in turn, creates an opportunity for fraud by raising the possibility that an instrument holder will create multiple images of the check and send them to banks or other check processing entities simultaneously or sequentially over a short period of time. Products and services have become available to allow individuals and small businesses to image checks (made to the individuals or small businesses as payees) and submit them into the payment/settlement system for deposit. Consider, for example, an individual who has downloaded an application to a handheld mobile computing device that allows the individual to image a check (endorsed by the individual) and submit the image to the individual's bank for deposit. Such applications tend to be associated with a particular bank, and so if the individual has opened multiple accounts, he can acquire multiple corresponding imaging applications and simultaneously image and download the check to each of multiple banks. Moreover, the individual might subsequently walk into a bank or non-bank check processing entity and cash the physical check.

Assume that multiple images are sent to multiple banks (each, then, being a bank of first deposit) simultaneously, and that none of such first deposit banks detect that the check is a duplicate. Each bank submits the check through the settlement process, ultimately to the paying bank. The paying bank refuses payment to the multiple banks, either immediately or, if the fraud is not immediately detected, shortly after an initial payment. A reversed check is returned to the first deposit banks, and those banks (or their check guarantors) bear the loss. If the paying bank doesn't detect the item, the maker may catch the duplicate entries in reviewing its account and then return the multiple items to the paying bank, which then returns them to the multiple banks of first deposit.

### SUMMARY OF THE INVENTION

One or more embodiments of the present invention may recognize and address disadvantages of prior art constructions and methods.

In one embodiment, a method of determining if a check being presented to a check processing entity has been previously presented to a check processing entity includes providing a first computerized system that is accessible through a computer network and that is controlled by a check processing entity. Additionally, a database is provided having records therein corresponding to checks, wherein each record includes data identifying an instance in which the check corresponding to the record is presented to a check processing entity for conversion to funds. Further, a second computerized system is provided that is accessible through the computer network and that is configured to query the database. At the check processing entity, a presentation of a first check is received where the first check is made to a payee to convert the first check to funds. In response to the presentation, a query is sent from the first computerized system to the second computerized system via the computer network, wherein the query identifies the first check. At the second computerized system, the database is queried for previously-stored records corresponding to the first check. In response to results of the querying step, information is sent from the second computer system to the first computer system indicating whether one or more prior instances of presentation of the first check to a check processing entity were found in the database.

In another further embodiment, a method of determining if a check being presented to a check processing entity has been previously presented to a check processing entity includes receiving a request to convert a check made to a payee to funds. A query is performed on a check processing database to retrieve information about the check indicating whether a query has already been performed on the check processing database for the check when the check had been presented to a check processing entity for conversion to funds. In response to determining that a query for the check had previously been performed on the check processing database, an indication is provided that the check is duplicative so that the check would not be accepted for settlement.

In another further embodiment, a method is directed to determining if a check that is made to a payee and that the payee presents to a check processing entity for conversion to funds has been previously presented to a check processing entity. A database is provided whereby the database is remote from the check processing entity and having records therein corresponding to checks, wherein each said record includes data identifying an instance in which the check corresponding to the record is presented to or accepted by a check processing entity for conversion to funds. Additionally, a computerized system is provided that is remote from the check processing entity and accessible through a computer network and that is configured to query the database. At the computerized system via the computer network, information is received identifying a first check and indicating the first check has been presented for conversion to funds. In response to receiving the information, and at the computerized system, the database is queried for previously-stored said records corresponding to the first check.

In a still further embodiment, a system is provided for detecting fraud relating to a check that is made to a payee and that the payee presents to a check processing entity for conversion to funds. The system includes a database remote from the check processing entity and having records therein corresponding to checks. Each record includes data identifying an instance in which the check corresponding to the record is presented to a check processing entity for conversion to funds. The system further includes a computer readable medium containing program instructions and a computerized system. The computerized system is remote from the check processing entity, accessible through a computer network, configured to query the database, and has a processor being in operative communication with the computer-readable medium and adapted to execute the program instructions to implement a method. The method includes receiving, at the computerized system via the computer network, information identifying a first check and indicating the first check has been presented for conversion to funds, and in response to receiving the information, and at the computerized system, querying the database for previously-stored records corresponding to the first check.

In a still further embodiment, a method of determining if any party, of a plurality of parties that participate in transactions that convert checks to funds and that have access to a computerized system that is remote from the parties, has submitted information to the computerized system identifying a check, includes providing a database remote from the parties and having records therein corresponding to checks. Each record includes data identifying an instance of submission by a party of the plurality of parties of information identifying a respective check. The computerized system is provided remote from the parties that is accessible through a computer network and that is configured to query the database. Information is received, at the computerized system via the computer network, that identifies a first party and confirms the first party is a party of the plurality of parties. First information is received, at the computerized system via the computer network, from the first party identifying a first check. In response to receiving the information, and at the computerized system, the database is queried for previously-stored records corresponding to the first check.

### BRIEF DESCRIPTION OF THE DRAWINGS

A full and enabling disclosure of the present invention, including the best mode thereof directed to one of ordinary skill in the art, is set forth in the specification, which makes reference to the appended figures, in which:

FIG. 1 is a schematic view of a transaction made through an embodiment of the system and method according to the present invention;

FIG. 2 is another schematic view of a transaction made through another embodiment of the system and method according to the present invention;

FIG. 3 illustrates exemplary entries in a check processing database according to an embodiment of the present invention;

FIG. 4A illustrates an exemplary query and query result according to an embodiment of the present invention;

FIGS. 4B-4E illustrate exemplary graphical user interfaces through an embodiment of the system and method according to the present invention; and

FIG. 5 is a schematic view of a system according to an embodiment of the present invention.

Repeat use of reference characters in the present specification and drawings is intended to represent same or analogous features or elements of the invention.

### DETAILED DESCRIPTION

Reference will now be made in detail to embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

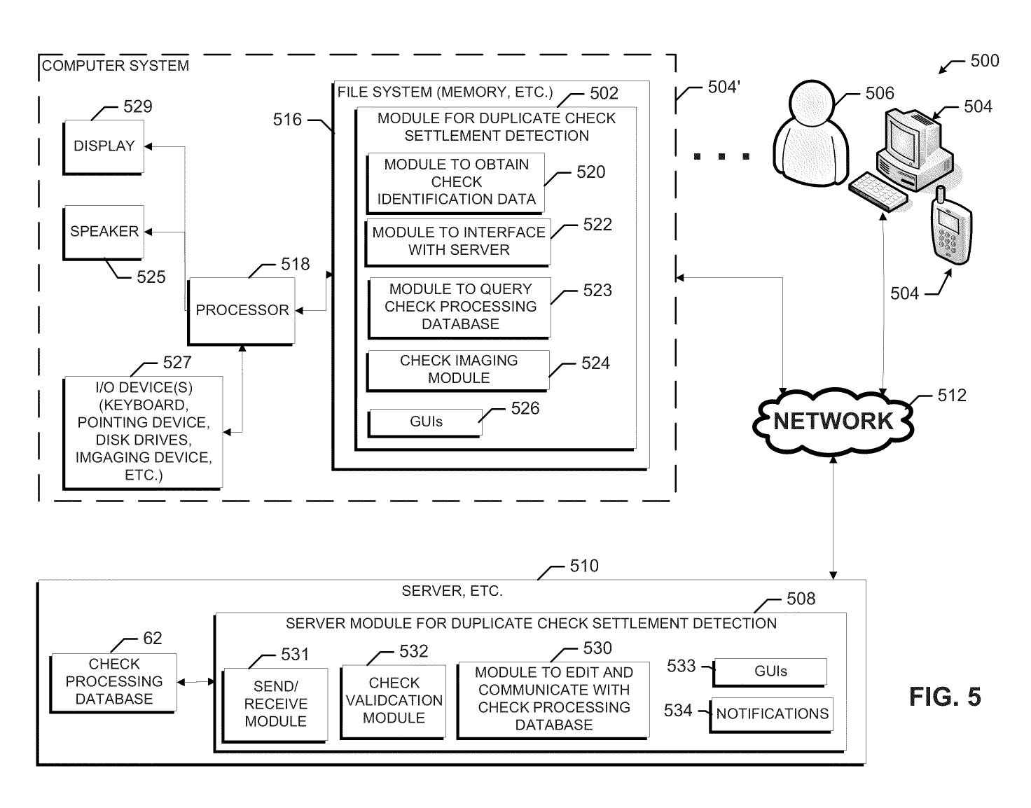

One or more embodiments of the invention described herein are implemented at least partially as and/or using computer programs for use with a computer system, such as, for example, the network environment shown in FIG. 5 and described herein. The programs define functions of these embodiments (including one or more methods described herein) and can be contained on a variety of computer-readable media, for example, information stored on non-writable storage media (such as CD-ROM discs readable by a CD-ROM drive), alterable information stored on writable storage media, and information conveyed to a computer by a communications medium, such as through a computer or telephone network, including wireless communications. The latter embodiment specifically includes information and functions downloaded from the Internet and other networks. Such computer-readable media, when carrying computer-readable instructions that direct the functions of one or more embodiments of the present invention, represent embodiments of the present invention.

In general, routines executed to implement embodiments of the present invention described herein may be part of an operating system for a specific application, component, program, module, object, or sequence of instructions. The computer program typically is comprised of a multitude of instructions that may be translated by a computer into a machine-readable format and hence executable instructions. Also, programs are comprised of variables and data structures that either reside locally to the computer program or are found in memory or on storage devices. In addition, various programs effecting methods described herein may be identified based upon the application for which they are implemented in a specific embodiment. However, it should be appreciated that the invention should not be limited to use solely in any specific application or function identified and/or implied herein.

Generally, some embodiments of the present invention solve the previously-presented, and/or other, problems by providing systems and/or methods, for example including computer program products utilizing a database, to determine whether a presented item has been previously presented, prior to accepting the item for conversion to funds. Exemplary such systems and methods provide a service to which check processing entities (banks or non-banks) and check validators/guarantors subscribe. The database includes records that identify instances in which a given check (identified in some manner specific to the item, e.g. MICR data, check image, etc.) has been previously presented to an entity such as a check processing or check validation/guarantor entity. A database management entity manages the database. When an entity considering whether to convert a check to funds sends a request about the check to the database management entity, the database management entity queries the database to thereby determine if the same check has been previously presented for conversion to funds. That is, in this example, the database management system queries the database to see if the database has a record reflecting such a previous instance. If such an instance exists in the database, the database management entity reports the instance to the requesting entity, who then makes a determination whether to convert the check to funds.

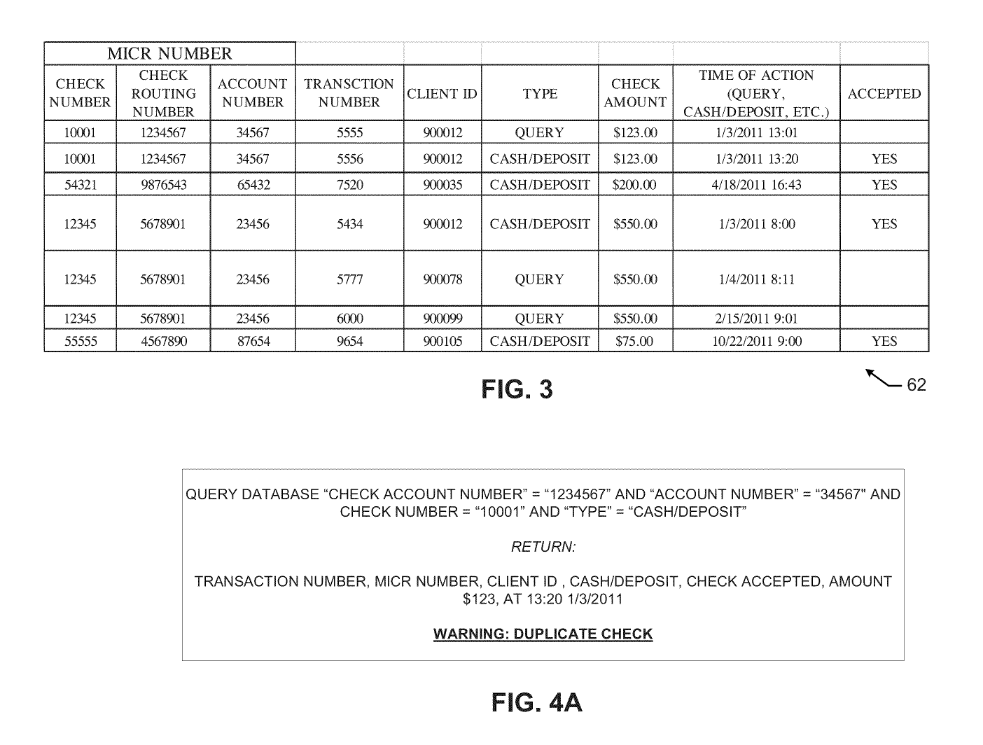

More specifically, for example, a check processing entity (or possibly a check guarantor to which the check processing entity has referred the check and/or other entity that has been assigned credentials by the database management entity) sends a message to the database management entity that directly or indirectly gives the check processing or check guarantor entity's identity, and provides identifying information about the check in question, e.g. an image of the check and/or alphanumeric data embodying the check ABA number, account number and check number (i.e. the MICR data). The requesting entity may send the request in response to a check payee's initial presentation of the check for conversion to funds, but it should be understood that a request may originate from other circumstances. After the initial presentation of the check and subsequent review of the check, a check processing entity may decide to convert the check to funds. At this later point, the check processing entity (or the check guarantor) may send to the database management entity a follow up message, again providing the requesting entity's identification and the check data, but also indicating the decision to convert the check to funds. Whether the request occurs at initial presentation or at check acceptance, the database management entity may consider the communication to be a database request and therefore execute a query against the database for prior instances of the same check and report the results to the requesting entity. In response to each such request, the database management entity creates a new database record that records in the database the date of the inquiry or follow-up submission with the item (i.e. personal, commercial, or government check or other negotiable instrument) identification. Thus, the database adds instances as they occur, which then become available as past instances for subsequent queries. An example of entries in a check processing database is illustrated in FIG. 3. As shown, various information is stored in the check processing database about various checks that payees have attempted to cash/deposit. Check processing database 62 is discussed in more depth below with regard to FIG. 3.

When the database management system receives a request, it checks its database to see if the database has any existing entries for that check. The manner by which the database identifies checks can vary, as should be understood. For example, checks on bank depository accounts often include check numbers, routing numbers, and account numbers (i.e. MICR data), and where a database is configured to provide information about such items, the database may identify items by MICR number, and queries may be made against the database to locate items having the same MICR number as the item in question. Alternatively, for example, the database records may identify checks by storing an image of the check. In such cases, the requesting entity may request a query by sending to the database management entity an image of the check in question, and the system may perform a pixel-based comparison of the check image received from the requesting entity against previously stored check images in the database, to see if the database has any existing entries corresponding to the received check image. Regardless how checks are identified, if the system finds existing database entries for the same check, it returns a response to the message sender, or requesting entity, indicating (a) that there have been other inquiries about the check, (b) how many such inquiries have occurred, and (c) the timing of such inquiries. Optionally, the response includes the identification of the check processing entity associated with the inquiry reflected by a previously-stored instance, i.e. the check processing entity to which the check was previously presented. The database management system may also return a message indicating whether any other entity has indicated it has accepted the check for conversion to funds, e.g. for deposit to a depository account or conversion to currency. In one embodiment, the database does not accumulate or report information about any check being refused or returned. It should be understood that the substance of the response may vary. For instance, in one embodiment, the response provides (a) the number of inquiries in the database for the requested check not associated with a confirmation the check has been converted to funds, (b) the number of inquiries in the database for the requested check that are associated with a confirmation the check has been converted to funds, (c) the requesting entity's identification, and (d) the unique (with respect to the database) identifier that will be associated only with the present inquiry.

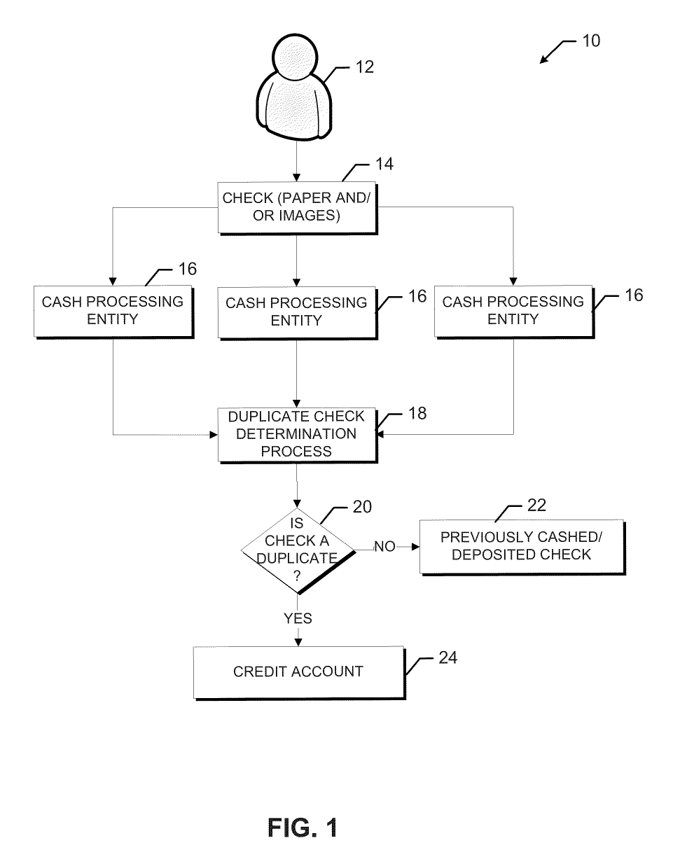

FIG. 1 illustrates a high level overview of a transaction 10 in accordance with an embodiment of the present invention, in which an individual or other entity 12 is initially a holder of a check 14. As used herein, the term “check” means a personal check, a draft, a money order, a traveler's check, or any other negotiable instrument, according to some embodiments.

Check 14 is made to entity 12 as the payee. Payee 12 presents the check to a check processing entity 16. In accordance with embodiments of the invention, the term “check processing entity” encompasses any organization that can process a negotiable instrument to a conversion to funds including, but not limited to, a bank, a credit union, certain governmental financial entities, an entity that performs check cashing, a third party entity contracted by a bank to process checks for conversion to funds, and the like. The term “check processing entity” encompasses a financial entity in which account-bearing customers conduct financial transactions, such as account deposits, withdrawals, transfers and the like but is not limited thereto. The payee may interact with such entity through a manned station, such as a teller station at a bank, or an automated station such as an automated teller machine. The check processing entity 16 could be a retailer of goods or a stand-alone check cashing entity.

Still referring to transaction 10, the check may be presented to the paying bank or other entity either electronically as an image or as a paper check, as is discussed below. Entity 12 may try to present the paper check and/or one or more images of the check to multiple check processing entities 16 over time or simultaneously, as represented by FIG. 1.

In block 18, a duplicate check validation process occurs to increase confidence that the check is not fraudulently presented in that it has not already been presented to this or another check processing entity for conversion to funds, i.e. initially presented to the check processing entity with a request either that the entity cash the check or deposit the check in a deposit account corresponding to the payee, or accepted by the check processing entity for cash or deposit after the initial presentation. This process uses a duplicate check processing database that may be accessed by multiple separate check processing entities (or other entities, such as check validators/guarantors) to verify the check being presented for settlement has not already been submitted to this or another check processing entity for payment or accepted by such entity.

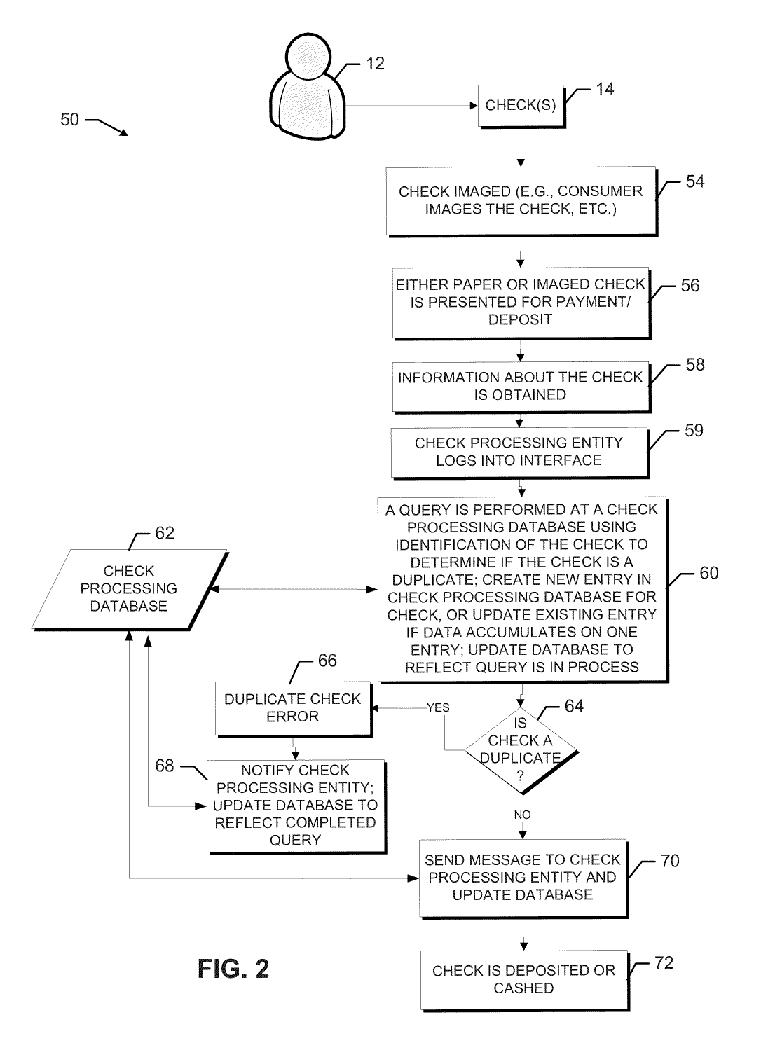

As will be discussed in more depth with regard to FIG. 2, the check processing entity sends information about the check to a database management system. The database management system, including its computerized system, is preferably remote from the check processing entity and its computerized system. “Remote” does not necessarily refer to the respective parties' physical relationship, but instead indicates that the parties do not have control over each other's computerized systems, including the databases and data thereof. The parties may be remote from each other, not necessarily indicating spatial separation, but instead indicating that no party has control over the other party's data and computer systems. The database management system may manage a check processing database (FIG. 2) and provide an interface (e.g. an application programming interface, or API) to the check processing entities and/or their guarantors to access in order to initiate the duplicative check determination process.

After information is sent to the database management system, and based on information contained in the database with regard to such check, the database management system performs a duplicate check assessment. The assessment may be entirely automated according to some embodiments. Based on the assessment, and corresponding information sent from the database management system to the check processing entity, an operator at the check processing entity may make a decision at 20 whether the check is or is not likely a duplicate of a check that has already been presented for processing or accepted, and therefore likely fraudulent. It should be understood as well that decision 20 may be automated at the check processing entity, in response to information provided by the duplicate check database managing system.

Although not shown in FIG. 1, the check cashing entity operator may also submit information about the payee and the check to a check guarantor service, which in turn returns a yes/no validation against the check, indicating whether the check processing entity should cash the check. Both the general check validation process and the duplicate check validation process may be performed by the check guarantor in a single validation process, or the two processes can be performed by separate entities in parallel with each other, simultaneously or in sequence. Thus, the general check validation process can, optionally, be part of one or more embodiments of the present invention, and process 18 should be understood to encompass the duplicate check validation process alone, the duplicate check validation process and the general validation process separately, or the duplicate check validation process and the general check validation process together. As the general check validation process should be well understood in the art, the present discussion is directed primarily to the duplicate check validation process, but it should be understood that the general check validation process may also be performed.

If decision 20 is that the check is not a duplicate (discussed in more depth with regard to FIG. 2), a check processing entity 16 may, at 24, credit the payee's account (if the payee has an account) or provide cash directly to the payee in currency if so requested, thereby ending the transaction. However, if the decision at 20 is that the check is a duplicate (i.e. that the same check has already been submitted for processing and/or has been converted to funds), the transaction 10 may end at 22. Again, this decision may be made manually by the operator at the check processing entity, or it may be made automatically by the check processing entity's computer system, but in either instance the decision is made in response to information provided by the duplicate check processing database system.

FIG. 2 illustrates a method of duplicate check validation in accordance with an embodiment of the present invention. A payee 12 is in possession of a paper check 14. To cash or deposit the check, payee 12 endorses the check such as by signing his name on the back of the check, writing “For Deposit Only” on the back of the check, or any other manner accepted under the laws and/or rules governing negotiation of commercial paper.

Payee 12 then images the check, for example by taking photographs of the front and back of the check with a digital camera or obtaining such images using an optical scanner. The check images are then stored on a computing device, such as a personal computer or mobile smartphone, as two image files. In one embodiment, the check images are obtained prior to the check being processed so that the check is shown as endorsed but not cashed or otherwise processed.

It should be noted that, if payee 12 presents a valid paper check to check processing entity 16, an operator at the facility may cash the check and then void the check so that the check cannot be used again. However, the payee may have already imaged the check prior to the check processing entity voiding the check, and, thus, the payee may try to cash the same check again. Additionally, it is appreciated that the payee could image the check multiple times, or replicate the image, or attempt to image the check after the check has already been processed and edit such images to put the images in a form where a check processing entity believes, at first impression, the imaged check has not yet been processed. Nonetheless, the presently described embodiments should detect presentment of multiple checks to one or more check processing entities, whether simultaneously or over time.

Still referring to FIG. 2, the check is presented for payment, as indicated at block 56, whether in paper or electronic form. If payee 12 presents the check electronically for conversion to funds (e.g. by forwarding to the check processing entity an image of the check from the payee's mobile device, which the payee has used to image the front and back of the check), the steps of method 50 following the check's presentation may be entirely automated. On the other hand, if the payee presents a paper instrument for conversion to funds, a human operator at the check processing entity may assist in performing one or more steps of method 50. For example, where the payee presents a paper check to a bank teller or a clerk at a merchant facility or other check-cashing entity, the teller or clerk may scan the check using known check scanning systems so that the entity's computer system has images of the front and back of the check. Or the teller or clerk may manually review the check and key the check's MICR into the entity's computer system. Where the payee interacts with the entity via an ATM, the ATM scans the front and back of the check, thereby imaging the check. Regardless, when the payee presents the check, whether as an image of the check or the paper check itself, the check processing entity obtains information/data about the check (block 58), for example including an image of the check and/or the check magnetic ink character recognition (“MICR”) data.

Check information may include, but is not limited to, the check routing number, the payor account number, the check number, the payor bank name and branch name, the payee, payor, date, check amount, an image of the check, and/or any other information contained on the check. This information may be obtained in various ways. As noted above, for example, an operator at the check processing entity can manually read and enter any of the check information into a computer system, or the payee may provide an image of the check to the entity's computer system by transmission from the payee's computer system or mobile device or via the entity's ATM, so that an optical character recognition (“OCR”) software program at the check processing entity's computer system scans the check images and extracts text contained on the imaged check. Once the OCR program extracts the text, the extracted text is then scanned to identify the type of data. For example, numbers extracted from the bottom left section of the check is identified as the MICR data, whereas the text in the center of the check relates to the payee, etc. It should be understood that the MICR data includes the check number, the check routing number, and the check account number. In one or more embodiments as described below, a duplicate check database may be queried simply by providing the MICR data to the duplicate database management system.

In one embodiment, information obtained about the check, as illustrated by block 58, may be the image of the check such that no text is inputted or extracted at the check processing entity. As discussed below, the duplicate check database request may comprise simply sending a copy of the check image to the database management system, and the database management system may perform the database query based on data extracted from the image or based on a pixel-by-pixel comparison of the image with check images stored from previous queries.

In block 59, check processing entity 16 (FIG. 1) logs into an interface. The interface may be controlled and operated by an entity that queries the database to determine whether there has been a past instance of the same check (i.e., the database management system in the presently-described embodiment). The interface (such as an API that operates in conjunction with the database management system's server program, as discussed below) allows check processing entity 16 to provide a username and password to the interface that is specific to that check processing entity 16 or to a given user at the check processing entity. Each check processing entity 16 of the overall group of check processing entities permitted access to the system has a profile associated with login credentials, and each profile may include the check processing entity name, and/or a specific user's name, and an identification character/number string (“client ID”). The name may be the name of the entity, and the identification character/number string an alphanumeric string generated by the database management system that is associated with and identifies the check processing entity. Once a check processing entity is logged into the interface, the profile data (e.g., the client ID, etc.) can be associated with a query to determine if a check is a duplicate, as discussed below.

The check processing entity may be provided with the interface or an application programming interface (“API”), which may be downloaded from the database management entity's server via the Internet. Thus, it should be understood that certain functions at the check processing entity computer system as discussed herein may be provided by the database management entity through a hosted environment. For example, the API may define a predetermined message format by which the check processing entity communicates queries to the database management system. In one embodiment in which the check processing entity logs into the database management system's hosted environment to then communicate with the system in an active session, the message format is fixed and includes the client ID, and the MICR of the subject check. The format may also include information identifying the teller/clerk, or ATM, sending the message and/or the check processing entity's local facility or branch from which the message originates. Such information is not used in the check inquiry process described herein but may be reported back to the check processing entity in a return message and/or utilized as part of an invoicing or accounting process. In an embodiment where the check processing entity does not log into the database management system, but instead simply sends query messages as needed, the message format is also fixed and may include the check processing entity's log-in information, so that databases management system validates authority on a message-by-message basis. In another embodiment, the predetermined format may comprise the client ID (along with optional ID information and, if needed, log-in information) and an image of the subject check. Various means by which the message format may be specified will be understood, e.g. the SOAP protocol specification.

In certain embodiments, messages in such a format (i.e. identifying the requestor and the check, but not identifying whether the check has been converted to funds) are inquiry messages. The message format, however, allows addition of an indication that the requestor has converted the check to funds. If the requestor selects that indicator for inclusion in the message, the database management system considers the message to be a confirmation message.

Still referring to step 59, assume the check processing entity has obtained and/or extracted identifying information from a check presented to it by a payee, and that a check processing entity user remote from the database management entity has logged into a database management entity interface (or, if log-in is not required on an active session basis, has entered log-in information to its system to be included in the outgoing message). The user now sends a query to the database management system in the form of a predetermined-format message, as described above, that acts, in turn, as a request to the database management system to query (at 60) duplicate check processing database 62 for previous instances of the check. The database management system may create and execute this database query in response to the receipt of the user's query (i.e. a message with the check MICR number, and/or a check image, and the check processing entity's identification, if an inquiry message, or additionally including information indicating conversion to funds, if a confirmation message) from the check processing entity, or the check processing entity can format the message itself (if allowed by the API) in the form of a database query that the database management system can then directly apply to the database. In either event, the check processing entity sends the query to the database management system by a computer system at check processing entity 16 (FIG. 1), over a connection via a local area network or a wide area network such as the Internet.

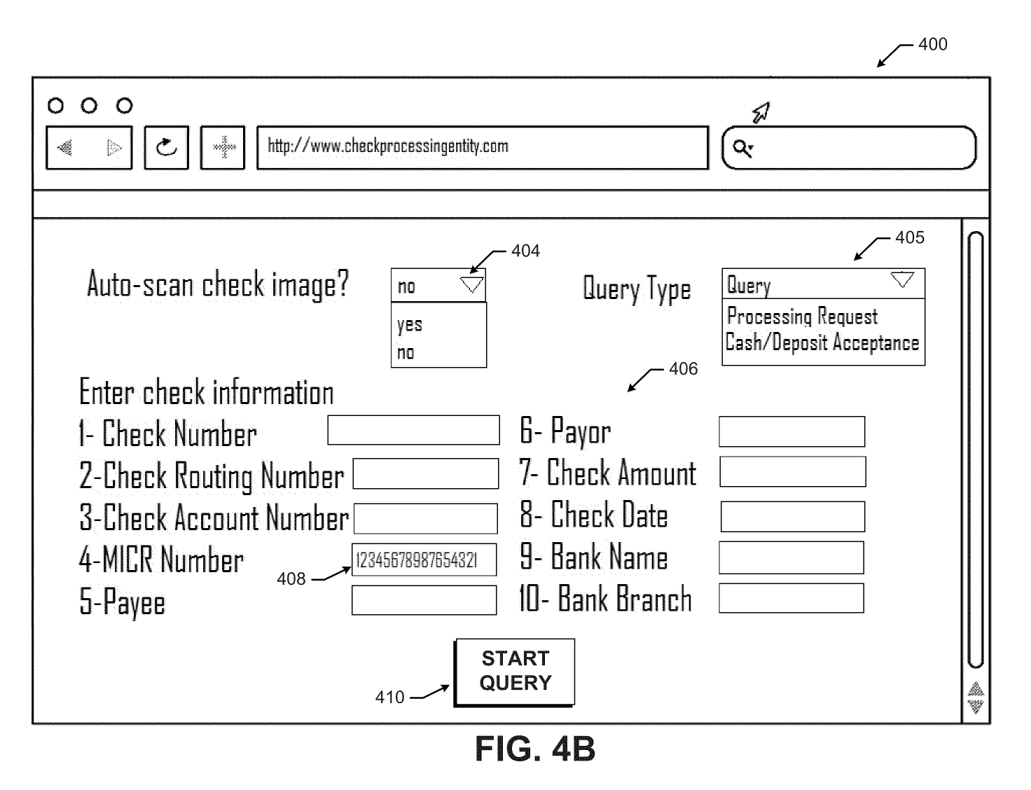

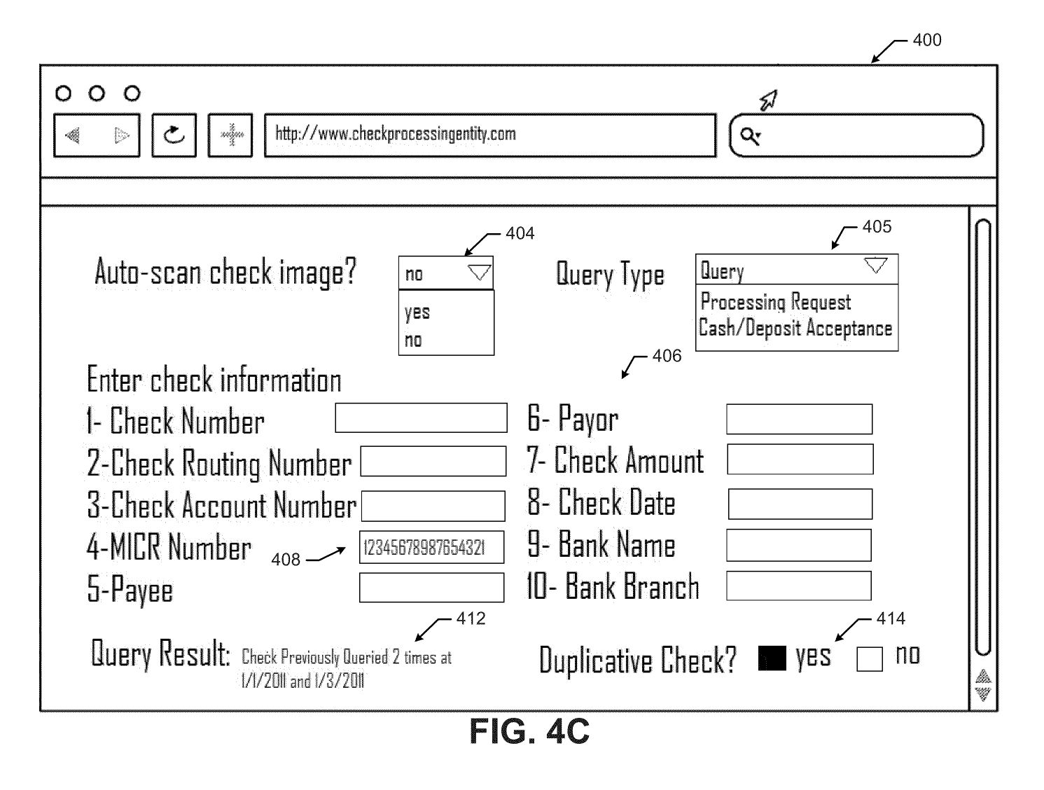

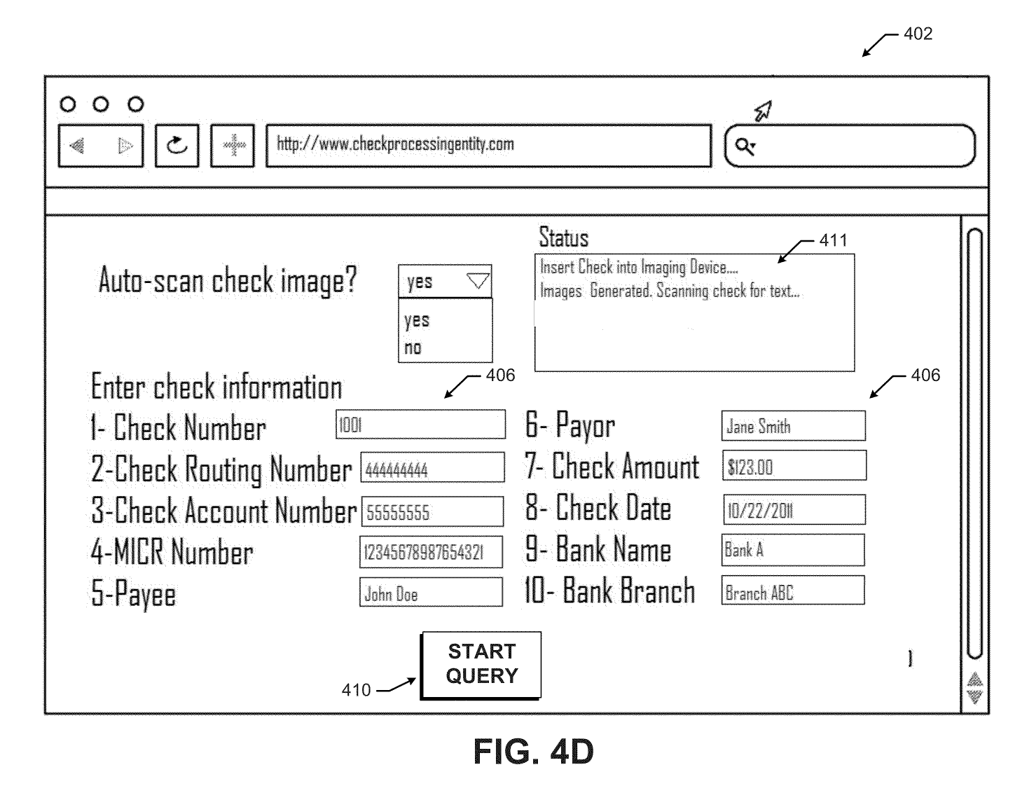

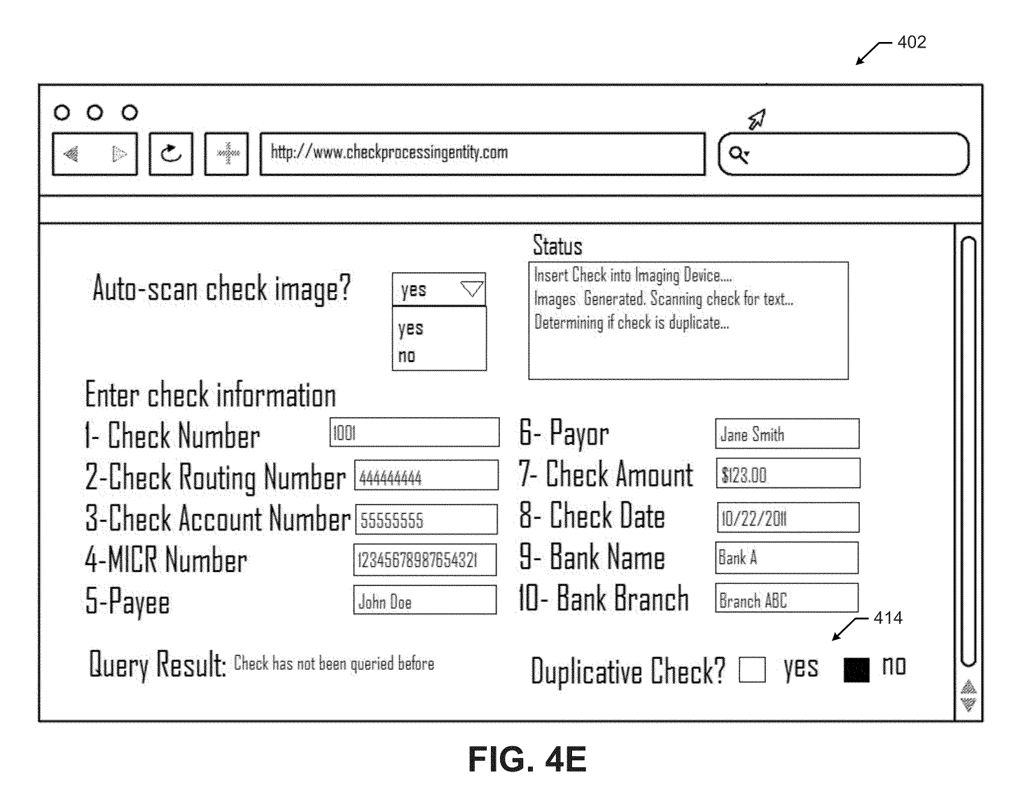

That is, the query (which may also be referred to herein as a request) from the check processing entity or guarantor to the database management entity is generally a message from a server or other computer associated with the check processing entity to a computer system associated with duplicate check processing database 62, but in some embodiments, the request is itself a database query message comprised of one or more commands to a server that manages the duplicate check processing database, indicating that the duplicate check processing database should be accessed and requesting information about the check. The query message also includes check identification data so that, when executed against the database by the duplicate check database management system, the query locates database instances (if any) for the identified check, and the database management system returns such data or corresponding information to the requester. An exemplary query (as well as exemplary graphical user interfaces) and result are illustrated in FIGS. 4A-4E, which are discussed in more depth below.

Thus, as noted above, the query need not have any commands and may be simply a transmission of data (i.e. data sufficient to identify the check, e.g. MICR data or an image of the check) from check processing entity 16 to a database management entity. That is, the transmission of the check information, without more, from the check processing entity to the database management entity, is sufficient to comprise a query.

Upon receipt of either type of query, the database management system may obtain the client ID due to the fact that the check processing entity is logged into the interface managed by or associated with the database management entity, or submits data reflecting the check processing entity's login information as part of an API communication, and the database management entity has previously assigned system credentials to the check processing entity. Alternatively, the system may obtain the client ID and log-in information from the query itself and confirm that this data matches previously-assigned credentials on a message-by-message basis. Where the check-processing entity is logged in, or if the system reviews log-in data on a message basis, and upon receipt of a query, the database management entity server obtains the profile of the logged-in check processing entity user, retrieves the client ID from its database that is associated with that profile, creates a transaction number that is unique to all query instances in the database and stores such transaction number along with the transmitted query data and the client ID into check processing database 62 as a new database entry. Alternatively, upon receipt of a query message from an authorized check processing entity, the database management system may rely on the client ID in the query, without retrieving the client ID from the user profile. With regard to FIG. 3, each new and accumulated entry in check processing database 62 includes: (1) the database-unique transaction number created when each corresponding request was received from a check processing or other entity or when a block of check data was transferred into the database; (2) any data transmitted to the database management entity from the check processing or other entity (e.g., MICR data, including check number, routing number, and account number); and (3) the date and time of the query when received by the database management entity or the time at which the data transfer occurred. Alternatively, rather than maintaining separate instances for each occurrence, the database may maintain a single entry for each check MICR number, and update that record with new information about requests as those requests occur.

In response to the received request, a server in the database management system queries duplicate check processing database 62 for the requested check and retrieves from the database any instances that may be stored in the database that identify previous queries against the requested check. If at 64 there is an earlier instance in the database (i.e. an instance created by an earlier query or data transfer) for the requested check (as identified, e.g. by matching MICR data or by a pixel-based image match), the server sends a corresponding notification 66 to the check processing entity at 68. In one embodiment, if there is at least one instance in the database for the same check number, the server sends data associated with each instance (e.g., MICR number, client ID of the entities that made the prior queries reflected in the instances, date/time of queries, etc.) back to the now-querying check processing entity at 68 so that the check processing entity can evaluate the information to determine if the check is a duplicate. Examples of such queries and the corresponding results are discussed below with regard to FIGS. 3-4. If the database has no such instance for the check at 64, the server sends a corresponding notification to that effect to the check processing entity at 70. The evaluation indicated at 64 may assess simply whether any database instance exists for a given check, and, if so, the system sends to the check processing entity at 68 a corresponding notification 66. Alternatively, the system may discriminate between instances that reflect queries against the check without conversion to funds (e.g. instances created in response to requests against the database made when payees initially present checks to check processing entities) and instances that reflect conversion to funds (e.g. instances created in response to requests indicating a check processing entity has accepted a check). Thus, the database management system may first query the database to determine if any instances exist for the check reflecting earlier queries against the database that were not a conversion to funds. If so, the system reports a corresponding notice 66 to the check processing entity at 68, and if not, the system reports a corresponding message at 70. Additionally, if at 64 there is an instance in the database that a check processing entity has deposited or cashed that same check, the server sends a corresponding notification 66 to the now-querying check processing entity at 68. If the database has no such instance for the check, the server sends a corresponding notification to that effect to the check processing entity at 70. Thus, the system may return the same or different response for the two types of instances, depending on the data.

Still further, assume that the query message from the check processing entity is an inquiry message. The database management system queries the database for all instances of the MICR identified in the query, determines the number of prior instances of inquiries for that MICR, determines the number of prior instances of confirmation for that MICR, generates the new unique transaction number for the present query/instance, and returns a response to the check processing entity including the returned inquiries, the returned confirmations, the new transaction number, the check MICR, the client ID, and the optional identification information, if any that was provided in the original query. If the query message from the check processing entity is a confirmation message, the database management system in one embodiment does not execute a query against the database but instead generates a new unique transaction number and returns a response to the check processing entity including the new transaction number, the check MICR, the client ID, and any optional ID information included in the original query. Thus, in this embodiment, the database management system treats inquiries as requests for information regarding past check processing instances for the requested MICR, and responds with corresponding information, and treats confirmations as reporting messages needing only a receipt-type response.

In a still further embodiment, the database management system may respond to inquires, or to both inquiries and confirmations, with a more qualitative response, indicating whether the requestor should accept the check for conversion to funds. For example, in addition to or instead of the numbers of past inquiries and confirmations (in response to an inquiry), and in addition to the information provided in response to a confirmation, the database management system may query the database against the MICR in the request and return a positive indication if the database indicates there are no past instances for the requested MICR, a normal warning if there is only one past inquiry and no past confirmations, and a “reject” warning if there is anything more than one past inquiry and no past confirmations.

Although the present description illustrates one or more examples in which the database management entity server checks MICR data of a requested check against MICR data stored in the database entries, it should be understood that other methods of identifying check records may be used. For example, assume that the check processing entity queries the database management system by sending an image of the check in question in a message as described above. As discussed above, the database management system associates the incoming check image with the client ID and the date and time the query was received from the check processing entity, creates a transaction number, and stores the number in database 62 in association with the client ID, the time stamp, and the check image. Thus, again, the database accumulates check instances through the stored requests (and data transfers) but does so with check images instead of, or in addition to, MICR data. When the database management system receives a new query, it executes an image compare routine at 60 that compares the image data in the query with the image data stored in the database, looking for a match. Image comparison methods should be well understood in this art, and so are not discussed in detail herein, but it should be understood that that the degree of similarity needed to declare a match can be selected. Thus, for example, the system may be set to declare a match if the request image matches a stored image by a predetermined, but selectable, percentage. If at 64 the system determines there is a match, it may return a report 66 to the querying check processing entity at 68 that includes the queried check image, with a message that the system determined that a query was made against the check, by a given client ID, on a given date and time. If a database instance at 64 reflects that a check processing entity has deposited or cashed the check, the reporting message 66 includes an indication that the given instance reflects that the check was converted to funds. If the database management system finds no instance of the check in the database at 64, then it returns the check image to the check processing entity at 70, in or with a message that the database contains no instance corresponding to the imaged check. Also, the system may operate as discussed above, with regard to inquiries and confirmations, in an embodiment where MICR data is replaced by a check image, as discussed herein.

At both 68 and 70, the server creates a new record in duplicate check processing database 62, indicating the check (identified by MICR data or image, as noted above) has been queried on the present date/time, and optionally indicating the identity of the check processing entity that initiated the query. As noted above, if the query corresponds to a check's acceptance (e.g. a confirmation query), such information may also be included in the newly created record.

Upon receiving a response from the database management system, the check processing entity makes a determination whether the check is a duplicate, in response to the query results. Assume, for example, that a request against the duplicate check database is made in response to presentation of a check for conversion to funds. If the database query results return an earlier instance for the check, in which the requested check either was presented for conversion to funds or was accepted by the same or a different check processing entity, the check processing entity may determine that the check is likely a duplicate and therefore reject the request to convert the requested check to funds.

Note that a check processing entity may make two queries, one at the time of presentation, and one at the time the check processing entity decides to accept the check. The check processing may make an inquiry-type query at this initial point. Assume the initial query results in a response from the database management system that no duplicate instance was found (i.e. no prior inquires and no prior confirmations). The database management system adds an instance to the database corresponding to this inquiry. If the check processing entity then accepts the check for conversion to currency or deposit at 72, the check processing entity may send an additional message to the database management system, indicating such acceptance (i.e. a confirmation). If, in response to the confirmation message, the database management system returns past instances for the subject MICR, the requestor will see the prior inquiry but will understand this is not fraud. If, as discussed above, the database management system does not execute a database query in response to the confirmation query but instead responds with a receipt-type response, the requestor will not see the previous inquiry. As indicated above, the database management system then creates a new database entry for such accepted check along with a new transaction number, the check details/data, the client ID of the check processing entity, and the data and time of acceptance. Alternatively, the database management system may not create a new record, but instead modify the most previous instance for the check to reflect acceptance. This ends the sequence of this embodiment of method 50.

As indicated above, the check cashing entity may also have employed a general check verification procedure against the check, either internally or through a separate check validation service (i.e. the check processing entity may itself perform the check validation function, or it may rely on a separate party, e.g. the duplicate check processing database management system), and thus the decision at 72 may be based on the general check validation results and the duplicate check validation results.

FIG. 3 illustrates exemplary entries in duplicate check processing database 62 (FIG. 5). Entries may include “MICR number” (which includes the “check number,” “check routing number,” and “account number”), “transaction number,” “client ID,” “type,” “check amount,” “time of action,” and “accepted” status. The check number refers to the number (typically printed) on the check to indicate the order in which the check falls in the maker's checkbook. The check routing number refers to the routing number printed on the check. The account number refers to the maker's account number against which the check is drawn. The transaction number refers to the number created when a query is being received by the database management system, as discussed above. The client ID refers to an alphanumeric identifier which identifies the check processing entity performing the query, as discussed above. The “type” section indicates whether the record corresponds to a query from the check processing entity that the check processing entity has cashed or deposited the check (i.e. a confirmation-type query), or solely a query by the check processing entity against the duplicate check database to determine whether the check is a duplicate (i.e. an inquiry-type query). The check amount provides an indication as to the amount for which the check is made. The “time of action” section indicates the time the duplicate check database management system received the query. The “Accepted” section provides an identification whether the check was accepted by the maker's bank, which is to pay the funds on the cashed or deposited check. In another embodiment, the “Check Amount” and “Accepted” sections are omitted. A “Note” section (not shown in FIG. 3) may be provided to permit a user or computing device at the duplicate database management system to enter miscellaneous notes or data as desired.

In a still further embodiment, the database accumulates query instances in two separate tables, one for inquiries and one for confirmations. In this arrangement, the “Type” column is also omitted, because an instance's inclusion in one table or the other identifies the instance as an inquiry or a confirmation. Thus, the “Type” section is not needed.

In certain presently-described embodiments, a “query” encompasses any request for information about a given check (e.g. as identified by MICR number) against the duplicate check database. For instance, the check processing entity may query the database whether any check queries have been made previously, or it may query the database as to whether a given check has been converted to funds, or both. In either case, this would be a query against the database for a given check, and the duplicate check database management system server creates a query data record, as shown in FIG. 3. In another embodiment, the duplicate check processing database management system and the check processing entities contractually agree that the check processing entities will query the duplicate check processing database in only two circumstances: (a) when a party presents the queried check to the check processing entity for cash or deposit, and (b) when the check cashing entity cashes or deposits the queried check. Thus, in this latter circumstance, the database records reflect check processing, or actual attempts to process the check, rather than mere informational queries that might not be associated with actual check processing. Such an embodiment is based on the assumption that a duplicate check condition occurs only with regard to actual check processing, or attempts to process checks, but it should be understood that the conditions under which the database may be considered to be queried may vary, e.g. based on agreement or convention among check processing entities as to what conditions constitute duplicate check processing.

It should be noted that check processing database 62 may be a single database or multiple databases. In this regard, some of the information may be in one database while other information may reside in one or more databases, but such databases may be simultaneously accessible by one or more servers to access information contained within such databases.

In FIG. 3, the first entry refers to check 10001, with routing number 1234567 and account number 34567, and shows that a query was made against the database for this check on January 3, 2011. The second entry indicates this same check (as identified by the MICR data) was cashed or deposited later the same day. The query that generated the first entry would not have caused the system to return a duplicate check message (or, would have triggered a response of zero inquiries and zero confirmations), because there were no prior instances of this check MICR number. The subsequent query, with the cash/deposit message, would cause the system to return information identifying the first query instance, but the check processing entity submitting the second query would recognize the first query as its own and thus would not determine this to be an instance of fraud. Alternatively, if this query was treated as a confirmation as discussed above, the system would return no prior instance data but would simply return the check data, the client ID, and the unique transaction number for the query. The third entry indicates check 54321, with routing number 9876543 and account number 65432, was cashed or deposited on April 18, 2011, without earlier query. Each of the first, second, and third examples would indicate normal activity (although each would prompt a finding of a duplicate check if the check were subsequently queried). Note, however, check number 12345, with routing number 5678901 and account number 23456, for which multiple queries are made by different banks or other check processing entities. Submission of the second query triggers the system to return information on the first instance, in this case indicating a likelihood of fraudulent processing attempts because (1) the second query against the subject check was performed after the check has been cashed or deposited, as indicated by the first instance; and (2) multiple check processing entities are performing such queries.

In one embodiment, data in the duplicate check processing database 62 does not store indefinitely. The system may assume, for instance, that fraud risk may exist for only a limited time, e.g. for the time needed to clear the check through the payment/settlement system. Thus, for example, the check processing database 62 could be set up so that data automatically deletes after some predetermined time, e.g. two or three weeks.

In the above-described embodiments, the duplicate check processing database management system automatically responds to a check processing entity each time the entity queries the database for a check. In another embodiment, however, the system may allow the check processing entity to make a query, and within that query the check processing entity may make a separate request for a query response from the database management system. If the check processing entity makes a query without requesting a response, the duplicate check processing database management system creates a query record, as described above, but does not notify the check processing entity whether the database has any instances of previous queries. In either embodiment, the system may allow a check processing entity to download to the database management system a list of checks that the check processing entity has previously accepted for cash or deposit (and/or, if available, checks for which the check processing entity has previously received requests to cash or deposit). Each event in such lists corresponds to a check query as described above, and the database management system creates corresponding records in duplicate check database 62 as described above but does not issue responses to those queries. In one embodiment, the duplicate check processing database management system charges a fee to the check processing entities on a per-response basis.

FIG. 4A illustrates an exemplary query based on the database example of FIG. 3.

The query command is illustrated at the top of the Figure as:

“QUERY DATABASE “CHECK ACCOUNT NUMBER”=“1234567” AND “ACCOUNT NUMBER”=“34567” AND CHECK NUMBER=“10001” AND “TYPE”=“CASH/DEPOSIT” ”

The data in the request (i.e. the MICR data) identifies with specificity which check should be queried in duplicate check processing database 62. Of course other querying parameters may be possible, such as the total raw MICR number, the check processing entity name or other ID, payee, payor, and/or any other data from the check having corresponding data in the database. As previously mentioned, a query need not contain a command and instead could simply be a message from the check processing entity comprising information about a check, such as the MICR number and/or check image. Regardless, if the check of interest is located in an instance of the duplicate check processing database, the database management system server responds to the query with information from that instance. In the example shown in FIG. 4A, the query returns the following:

“CHECK NUMBER 10001, BANK A, CHECK CASHED, PAYEE JOHN DOE, PAYOR JANE SMITH, AMOUNT $123, AT 13:01 1/1/2011.”
Note that the response does not list both queries for this check listed in the database, but it should be understood that the system may be configured to respond with information identifying all prior query instances for the check in the database or, as noted above, may separately identify the number of inquiries and the number of confirmations. As indicated, this example could be considered a confirmation, and in that event, the response might not return any past instance information at all, but instead only the query information itself, along with the new transaction number. Because the database management system returns a response with one or more query instances, the response may also include a warning, as discussed above, indicating the check may be a duplicate, but it should be understood that the response may not include such warning and report only the instance occurrence(s).

FIGS. 4B-4E illustrate graphical user interfaces 400, 402 for performing duplicate check settlement detection according to some embodiments. In FIG. 4B, the graphical user interface may be presented to a user at a check processing entity to determine if a check that is being presented for settlement is a duplicate. In this particular embodiment, a check may be physically presented to a user at the check processing entity. The user then selects a dropbox 404 using a mouse as to whether the user would like to auto-scan the check image. “Auto-scan” refers to a process of allowing a computing device to extract information displayed on the check so that the computing device can obtain check data, as previously discussed with respect to FIG. 2. To perform such selection, the user selects with the cursor the down arrow in dropbox 404 and selects either “yes” or “no.” In FIGS. 4D-4E, the user has selected “no,” which means that the user will manually enter one or more parameters of the check by manually inspecting the check and keying the data into fields 406 on the graphical user interface 400.

At a dropbox 405, the user selects whether the query corresponds to an initial request from a payee to process (e.g. cash or deposit) the check, or to the check processing entity's acceptance of a check for cash or deposit. In the examples in FIGS. 3 and 4, the user selects “processing request,” indicating the event corresponds to an initial request from a payee to process a check. A third dropbox (not shown) may also be provided to allow the user to select whether a response is desired from the duplicate check processing database management system.

It should be noted that not all fields need to be entered for the query. For example, as illustrated in FIG. 4B, only the MICR number is entered or typed into a field 408, and options for dropboxes 404 and 405 selected. In this embodiment, the minimum information needed to establish a query comprises the selection at dropbox 405 and either the check number/account number or the MICR number. Given entry of at least this information, the user clicks the “START QUERY” button to thereby automatically run executable computer code on the user's computer that compiles a query command such as presented above with regard to FIG. 4A and communicates such request (e.g. via a LAN or WAN connection) to the duplicate check processing database management system server. The database management system server then searches the database as described above and returns an appropriate response (as described above) to the user's computer for display to the user. As described above, the database management server may return a response automatically, but in embodiments where the user selects whether a response is desired, may do so in response to such user instruction.

FIG. 4C illustrates an exemplary display at the user's computer of a response from the duplicate check processing database management system to the query illustrated in FIG. 4B. In this case, the duplicate check processing database management system located two database instances corresponding to the MICR number of “12345678987654321.” The queried result is presented at a bottom portion 412 of graphical user interface 400, indicating that the check was previously queried two times and presenting the dates of the previously queries. The number of queries (i.e. 2) corresponds to the number of database instances found that correspond to data in the MICR number (e.g. the check number plus the account number, or those numbers in combination with the routing number), and the dates of previous queries are retrieved from those instances. Graphical user interface 400 may also give a “yes” or “no” indication (as to whether the check is likely a duplicative check, e.g. “yes” if acceptance has occurred, otherwise “no”) in a portion 414 of the graphical user interface 62, but in another embodiment portion 414 is omitted, and the system provides only the information regarding the occurrence of prior queries. As described above, duplicate check processing database 62 is updated to include a new instance corresponding to this query.

FIGS. 4D and 4E illustrate a query being performed when the auto-scan image selection is “yes.” An imaging device images the front and back of the check, extracts text and identifies the extracted text is, as discussed above. This text data may then be presented to the user in the graphical user interface 402 in the presented fields 406. It is noted that there may be a “Status” section 411 in graphical user interface 402 that provides a real-time update on the processes being performed by the user computer processor.

After the data has been determined, the user can verify the extracted data by visual inspection and, when ready, activate the “START QUERY” button 410 by clicking the mouse after hovering over button 410. The user's computer processor compiles a query command and communicates such request to the duplicate check processing database management system server. The database management system server then searches the database as described above (e.g., based on the check number/account number or those numbers in combination with the routing number) and returns an appropriate response (as described above) to the user's computer for display to the user. As described above, the database management server may return a response automatically, but in embodiments where the user selects whether a response is desired, may do so in response to such user instruction.

FIG. 4E illustrates the results of the query initiated in FIG. 4D according to an embodiment. As illustrated, the result of the query returns the result that the check has not been queried prior to the present query and thus, the graphical user interface presents to the user that the check is not a duplicative check at 414. Again, portion 414 may be omitted in another embodiment.

FIG. 5 is a block schematic diagram of a system of duplicate check settlement detection in accordance with an embodiment of the present invention. The system 500 may include a module for duplicate check processing detection (hereinafter “duplicate check detection module”) 502 operable on a computer system 504, or similar device of a user 506 or client at the check processing entity. System 500 also includes a duplicate check detection module 508 operable on a server 510 (hereinafter “server duplicate check settlement detection module”) at and/or controlled by the duplicate check database management entity. Server 510, including database 62, may be considered the duplicate check processing database management system. Server 510 is accessible by user 506 computer system 504 via a network 512 such as the Internet. The methods discussed above may be embodied in or performed by the duplicate check detection module 502 and/or the server duplicate check detection module 508 in conjunction with a user at the check processing entity. That is, some of the features or functions of the presently described methods may be performed by the duplicate check settlement detection module 502 on the user's check processing entity computer system 504, and other features or functions of the presently described methods may be performed on the database management system server duplicate check detection module 508.

The check processing database 62 may be operable on the server 510 or may be operable separate from the server 510 and may be communicable by users 506 using their respective computer systems 504 or clients. The check processing database 62 may be the same as discussed above with respect to FIGS. 2-3.

Network 512 may be the Internet, a private network or other network. Each computer system 504′ may be similar to the exemplary computer system 504 and associated components illustrated in FIG. 5.

Each duplicate check detection module 502 and/or 508 may be a self contained system with embedded logic, decision making, state based operations and other functions that may operate in conjunction with collaborative applications, such as web browser applications, email, phone applications and any other application which can be used to communicate with an intended recipient. Check processing entities may utilize the self contained systems as part of a process of validating checks prior to acceptance for deposit or cash.

Duplicate check settlement detection module 502 may be stored on a file system 516 or memory of the computer system 504. Duplicate check settlement detection module 502 may be accessed from file system 516 and run on a processor 518 associated with computer system 504.

Duplicate check settlement detection module 502 may include a module 520 to obtain check data (hereinafter “check data module”). Check data module 520 obtains information contained on the check. For example, check data module 520 may receive manually-inputted check information, such as the check number, check routing number, check MICR number, payee and payor information, or any other information resident on the check. Check data module 520 may also (or alternatively) have a sub-module that can extract the same check information (e.g., check number, check routing number, check MICR number, etc.) from the check using computer system 504 or other computing device. In this regard, check data module 520 may operate in conjunction with an imaging device (e.g., a scanner, camera, etc.) to receive an image of the check and then run an OCR routine to extract textual information visually present on the check and determine the respective types of extracted data, such as whether given text is a check routing number, check account number, payee, check amount, etc. Check data module 520 may be accessed or activated through a user interface whenever a check is presented to the check processing entity for processing and may call other modules such as GUIs 526 as described below. Check data module 520 also allows input of other information, such as searching preferences, passwords and the like. Check data module 520 may communicate with any module on the server 510 to obtain or verify the check data or for other reasons.

Duplicate check settlement detection module 502 may also include a module 522 to interface with the server (hereinafter “server interface module”). Server interface module 522 allows for interfacing with modules on server 510 and communicates with server 510 to upload and/or download requested data and other information. As such, computer 504 may act as both a requesting device and an uploading device. Additionally, server interface module 522 allows for transmission of data and requests between the computer 504 and server 510. For example, server interface module 522 allows for a query message to be transmitted to the server and also allows for receipt of the results. Server interface module 522 distributes data received to the appropriate module for further processing.

Duplicate check settlement detection module 502 may also include a module 523 to query database 510 (hereinafter “query module”). Query module 523 allows a user to query data from server 510 and, thereby, from check processing database 62. As illustrated in FIG. 4A and discussed above, the query may take the form of a command message that presents a command to the server, which in turn compiles the command and executes the requested function, such as retrieving information from duplicate check processing database 62. Query module 523 communicates with server 510 to upload a query and download requested items that are requested via server interface module 522. After transmission of a query message and retrieval of the query results, query module 523 may store the retrieved data in the memory for future retrieval.

Duplicate check settlement detection module 502 may also include graphical user interfaces (“GUIs”) 526. Duplicate check settlement detection module 502 may present one or more predetermined GUIs to permit the user to input/select data, direct computer 504 to perform certain functions (e.g., image a check, execute a query, save received check data, etc.), define preferences associated with the query, or allow the user to input any other information and/or settings. GUIs 526 may be predetermined and/or presented in response to the user attempting to perform a query or enter information and/or settings. Duplicate check detection module 508 and/or module 502 may generate the predetermined GUIs 526, which may be presented to the user on a display 529 of computer system 504. GUIs 526 also present users notifications, such as the duplicate check database responses discussed above. GUIs 526 may allow the user to custom define a query, such as changing a query command or changing a query's search parameters. GUIs 526 can be custom-defined and execute in conjunction with other modules and devices on the user's computer 504, such as I/O devices 527, the module to interface with the server 522, or any other module. Examples of GUIs were previously illustrated with regard to FIGS. 4B-4E.

User computer system 504 may also include a display 529 and a speaker 525 or speaker system. Display 529 may present applications for electronic communications and/or data extraction/uploading/downloading/etc. and may perform controlling and display of the check information, notifications, etc. as described herein. Any GUIs 526 associated with duplicate check detection module 508 and application may also be presented on display 529. Speaker 525 may present any voice or other auditory signals or information to user 506 in addition to or in lieu of presenting such information on display 529.

User computer system 504 may also include one or more input devices, output devices or combination input and output device, collectively I/O devices 527. I/O devices 527 may include a keyboard, computer pointing device, an imaging device (e.g., a camera, scanner, etc.), a data extraction device, or similar means to control operation of applications and interaction features described herein. I/O devices 527 may also include disk drives or devices for reading computer media including computer-readable or computer-operable instructions.

Duplicate check settlement detection module 502 may also include a check imaging module 524. Check imaging module 524 communicates with an imaging device to obtain an image of a check. The format of the image that the imaging device may output could be any imaged file output, such as JPEG, GIF, or Bitmap, but may also be in HTML or PDF form. The imaging device has an optical lens that captures an image of the check by capturing a still image of the check using light reflecting from the surface of the check. As previously, mentioned with regard to FIG. 2, images of both the front and back of the check may be captured since the front of the check has various required check deposit information and the back has endorsement information that may also required for cashing the check. After the imaging device captures front and back images of the check, the image files are then sent to check data module 520 (discussed above) to extract the text in the image. It should be noted that text is embodied in the image files, such that the text is a part of the image, but can be recognized and extracted using OCR software. If the check has already been imaged, check imaging module 524 need not be run, and instead the check data module 520 can extract the textual data from the image files.

As previously mentioned, server duplicate check detection module 508 may reside on server 510. It should be understood that server duplicate check detection module 508 may also, or alternatively, reside on another computer or on a cloud-computing device. One or more of the sub-modules of the server duplicate check detection module 508 may all run on one computer or run on separate computers.

Server duplicate check settlement detection module 508 may include a module 530 to edit and communicate with the duplicate check processing database (“database operations module”). Database operations module 530 may be configured to search database 62 in response to a query received from module 523 via module 531, as well as initiate, upload, download, manage, process and/or complete electronic communications with duplicate check processing database 62 and the check processing entity user's computer 504. Check processing database operations module 530 is configured to communicate with any of the modules in duplicate check detection module 502 on the user's computer 504. Database operations module 530 receives requests from the user's computer and performs any resulting queries and returns results back to computer 504 via send/receive module 531.

Send/receive module 531, which also resides on server duplicate check detection module 508, allows data to be sent between the user's computer 504 and the server 110. This may include the handling of queries, data from duplicate check processing database 62, etc. as well as the appropriate delivery to the correct module.

Server duplicate check detection module 508 further includes a duplicate check validation module 532. Duplicate check validation module 532 receives results from the querying of the duplicate check processing database and analyzes such results to determine if the check at issue is a duplicate check (or potentially duplicate check). To determine if the check is a duplicate or a potentially duplicate check, check validation module 532 checks the values of the query result to determine if an instance of a query against the check has been previously stored in the database (i.e. the past-queries value >0, or past-inquiries >0, and/or past-confirmations >0) and, optionally, the number of such instances (i.e. the past-queries value itself or the past-inquiries and/or past-confirmation themselves). If check validation module 532 determines that the check has been previously queried, check validation module 532 sends (via send/receive module 531) one or more notifications 534 (see 414 at FIG. 4) to the user's computer 504 along with the query results (see 412 at FIG. 4). As noted above, in one or more embodiments module 532 sends only the query results and does not provide notifications 534 to the user's computer. At this point, check validation module 532 indicates to check validation operations module 530 that the query has completed and that the check processing database 62 should be updated with a new query instance to reflect the present query, as discussed above. In response, module 530 creates a new instance and updates database 62 with the new instance. Module 530 may also generate notifications 534 to report to user computer 504 if errors occur or there are inconsistencies or incompatibilities in a query.

Server duplicate check detection module 508 may further include GUIs 533 and may present one or more predetermined GUIs to permit a user of the duplicate check database management system to define preferences and/or aliases associated with identities of end users or any other information and/or settings. The GUIs may be predetermined and/or presented in response to the user indicating the user would like to enter information and/or settings. The predetermined GUIs may be generated by server duplicate check detection module 508 and may be presented on a display (not shown) associated with server 510.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C ++ or the like and conventional procedural programming languages, such as the “C” programming language or similar programming languages, e.g. Microsoft .netC#. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the above description is set forth with respect to one or more embodiments, it should be appreciated the principles of the present invention are equally applicable to other embodiments within the scope of the present disclosure and claims. Such other modifications and variations to the present invention may be practiced by those of ordinary skill in the art, without departing from the spirit and scope of the present invention, one or more embodiments of which are more particularly set forth in the appended claims. In addition, it should be understood that aspects of the various embodiments described herein and otherwise may be interchanged both in whole or in part. Furthermore, those of ordinary skill in the art will appreciate that the foregoing description is by way of example only and is not intended to be limitative of the invention so further described in such appended claims.

What is claimed is:

1. A method of determining if a check being presented to a check processing entity has been previously presented to a check processing entity, the method comprising:
providing a first computerized system that is accessible through a computer network and that is controlled by a check processing entity;
providing a database having records therein corresponding to checks, wherein each said record includes data identifying an instance in which the check corresponding to the record is presented for conversion to funds;
providing a second computerized system that is accessible through the computer network and that is configured to query the database;
receiving, at the check processing entity, a presentation of a first check made to a payee to convert the first check to funds;
in response to the presentation, sending a query from the first computerized system to the second computerized system via the computer network, wherein the query identifies the first check;
querying, at the second computerized system, the database for previously-stored said records corresponding to the first check; and
in response to results of the querying step, sending information from the second computer system to the first computer system indicating whether one or more prior instances of presentation of the first check to a check processing entity were found in the database.

2. The method as in claim 1, further comprising, following the querying step, updating the database to include a record including data identifying the presentation of the first check for conversion to funds.

3. The method as in claim 1, wherein the information sent at the second sending step comprises a time of any instance identified in the information.

4. The method as in claim 1, wherein the receiving step comprises obtaining information displayed on the first check.

5. The method as in claim 4, wherein the obtaining information displayed on the first check comprises receiving information displayed on the check by:
receiving an image of a front side of the first check;
receiving an image of a back side of the first check; and
extracting textual data from the images of the front and back sides of the first check.

6. The method as in claim 4, wherein the information displayed on the first check comprises at least one of magnetic ink character recognition (“MICR”) number, routing number, account number and check number.

7. The method as in claim 4, wherein the obtaining information displayed on the first check comprises receiving information displayed on the first check by manual entry into the first computerized system.

8. The method as in claim 2, wherein the presentation of the first check for conversion to funds comprises an initial presentation of the first check to the check processing entity by the payee with request to convert the first check to cash or account deposit.

9. The method as in claim 2, wherein the presentation of the first check for conversion to funds comprises acceptance of the first check by the check processing entity for conversion to cash or account deposit.

10. The method of claim 1, wherein the query comprises a command to search the database to return a past-queries value indicating an occurrence of an instance in which the database has been queried for the first check prior to the query of the querying step.

11. The method of claim 10, wherein the querying step comprises:
receiving the past-queries value;
in response to the past-queries value being greater than zero, providing a determination that the first check had been previously presented for conversion to funds; and
in response to the past-queries value being equal to zero or there being no entry for the first check in the database, providing a determination that the first check has not been previously presented for conversion to funds.

12. A method of determining if a check being presented to a check processing entity has been previously presented to a check processing entity, the method comprising:
receiving a request to convert a check made to a payee to funds;
querying, using a computerized system, to a check processing database to retrieve information about the check indicating whether a query has already been performed on the check processing database for the check when the check had been presented to a check processing entity for conversion to funds; and
in response to determining that a query for the check had previously been performed on the check processing database, providing an indication that the check is duplicative.

13. The method as in claim 12, further comprising in response to determining that a query for the check on the check processing database has not been performed, providing an indication that the check is not duplicative.

14. The method as in claim 12, further comprising in response to either acceptance of the check or denial of the check, updating the entry associated with the check in the check processing database to indicate that a query has been completed.

15. The method as in claim 12, further comprising while performing the query, updating the entry associated with the check in the check processing database to indicate that a query has been performed.

16. The method as in claim 12, further comprising in response to determining that a query for the check is currently being performed on the check processing database by another entity, providing an indication that the check is duplicative.

17. The method of claim 12, wherein the query comprises a command to search the check processing database to return a past-queries value indicating how many times the check has been queried prior to the current query.

18. The method of claim 17, wherein the determining if the check had been previously attempted to be converted to funds comprises:
receiving the past-queries value;
in response to the past-queries value being greater than zero, providing a determination that the check had been previously attempted to be converted to funds; and
in response to the past-queries value being equal to zero or there being no entry for the check in the check processing database, providing a determination that the check had not been previously attempted to be converted to funds.

19. A method of determining if a check that is made to a payee and that the payee presents to a check processing entity for conversion to funds has been previously presented to a check processing entity, the method comprising:
providing a database remote from the check processing entity and having records therein corresponding to checks, wherein each said record includes data identifying an instance in which the check corresponding to the record is presented to a check processing entity for conversion to funds;
providing a computerized system that is remote from the check processing entity and accessible through a computer network and that is configured to query the database;
receiving, at the computerized system via the computer network, information identifying a first check and indicating the first check has been presented for conversion to funds; and
in response to receiving the information, and at the computerized system, querying the database for previously-stored said records corresponding to the first check.

20. The method as in claim 19, wherein the information is received at the receiving step from a sending entity, and further comprising the step, following the querying step, of sending to a computer system controlled by the sending entity via the computer network information indicating whether one or more prior instances of presentation of the first check to a check processing entity were found in the database in the querying step.

21. The method as in claim 20, wherein the sending entity is the check processing entity.

22. The method as in claim 19, further comprising, following the querying step, updating the database to include a record identifying presentation of the first check for conversion to funds.

23. The method as in claim 20, wherein the information sent at the sending step comprises a respective time associated with presentation of a check of each of one or more instances identified in the querying step.

24. The method of claim 19, wherein the information received at the receiving step includes information identifying the check processing entity to which the first check was presented.

25. The method of claim 24, wherein:
the computerized system assigns respective unique identification data to check processing entities,
in each said record stores the respective unique identification data for the check processing entity to which the check associated with the instance for said record was presented, and
the information sent at the sending step includes the identification data corresponding to the instances found at the querying step.

26. The method of claim 19, wherein the information received at the receiving step comprises magnetic ink character recognition data from the first check.

27. The method of claim 19, wherein the querying step comprises searching the database to return a past-queries value indicating an occurrence of an instance in which the database has been queried for the first check prior to the querying step.

28. The method of claim 27, wherein the querying step comprises:
receiving the past-queries value;
in response to the past-queries value being greater than zero, providing a determination that the first check had been previously presented for conversion to funds; and
in response to the past-queries value being equal to zero or there being no record for the first check in the database, providing a determination that the first check has not been previously presented for conversion to funds.

29. A system for determining if a check that is made to a payee and that the payee presents to a check processing entity for conversion to funds has been previously presented to a check processing entity, comprising:
a database remote from the check processing entity and having records therein corresponding to checks, wherein each said record includes data identifying an instance in which the check corresponding to the record is presented to a check processing entity for conversion to funds;
a computer readable medium containing program instructions; and
a computerized system remote from the check processing entity, accessible through a computer network, configured to query the database, and having a processor being in operative communication with the computer-readable medium and adapted to execute the program instructions to implement a method comprising
receiving, at the computerized system via the computer network, information identifying a first check and indicating the first check has been presented for conversion to funds; and
in response to receiving the information, and at the computerized system, querying the database for previously-stored said records corresponding to the first check.

30. A method of determining if a check that is made to a payee and that the payee presents to a check processing entity for conversion to funds has been previously presented to a check processing entity, the method comprising:
providing a database remote from the check processing entity and having records therein corresponding to checks, wherein each said record includes data identifying an instance in which the check corresponding to the record is presented to or accepted by a check processing entity for conversion to funds;
providing a computerized system that is remote from the check processing entity and accessible through a computer network and that is configured to query the database;
receiving, at the computerized system via the computer network, information identifying a first check and indicating the first check has been presented for conversion to funds; and
in response to receiving the information, and at the computerized system, querying the database for previously-stored said records corresponding to the first check.

31. The method as in claim 30, wherein the information is received at the receiving step from a sending entity, and further comprising the step, following the querying step, of sending to a computer system controlled by the sending entity via the computer network information indicating whether one or more prior instances of presentation of the first check to a check processing entity were found in the database at the querying step.

32. The method as in claim 31, wherein the information indicating whether the one or more prior instances were found in the database specifies whether the one or more prior instances correspond to presentation of a check to a check processing entity for conversion to funds or acceptance of a check by a check processing entity for conversion to funds.

33. A method of determining if any party, of a plurality of parties that participate in transactions that convert checks to funds and that have access to a computerized system that is remote from the parties, has submitted information to the computerized system identifying a check, the method comprising:
providing a database remote from the parties and having records therein corresponding to checks, wherein each record includes data identifying an instance of submission by a party of the plurality of parties of information identifying a respective check;
providing the computerized system remote from the parties that is accessible through a computer network and that is configured to query the database;
receiving, at the computerized system via the computer network, information identifying a first party, and confirming the first party is a party of the plurality of parties;
receiving, at the computerized system via the computer network, first information from the first party identifying a first check; and
in response to receiving the information, and at the computerized system, querying the database for previously-stored said records corresponding to the first check.

34. The method as in claim 33, further including the step, following the querying step, of sending to a computer system controlled by the first party via the computer network information indicating whether one or more prior instances corresponding to the first check were found in the database from the querying step.

35. The method as in claim 33, further comprising, following the querying step, updating the database to identify a said instance corresponding to receipt of the first information at the second receiving step.

36. The method as in claim 34, further comprising
following the querying step, updating the database to identify a said instance corresponding to receipt of the first information at the second receiving step; and
assigning, at the computerized system, an identifier to the instance created at the updating step that is unique in the database with respect to other said instances, and
wherein the information sent at the sending step includes the identifier.

37. The method as in claim 34, further comprising,
following the querying step, updating the database to identify a said instance corresponding to receipt of the first information at the second receiving step;
receiving, at the computerized system via the computer network, second information from a second said party of the plurality of parties identifying the first check and indicating the second said party has converted the first check to funds; and
in response to receiving the information, and at the computerized system, sending to a computer system controlled by the second party via the computer network information identifying the first check and updating the database to identify a said instance corresponding to receipt of the second information.
